(19) United States
(12) Patent Application Publication
(10) Pub. No.: US 2020/0408510 A1
(43) Pub. Date: Dec. 31, 2020

(54) KIT AND METHOD FOR CALIBRATING LARGE VOLUME 3D IMAGING SYSTEMS

(71) Applicant: NATIONAL RESEARCH COUCIL OF CANADA, Ottawa (CA)

(72) Inventors: Marc-Antoine DROUIN, Gatineau (CA); Michel PICARD, Ottawa (CA); Jonathan BOISVERT, Gatineau (CA); Guy GODIN, Ottawa (CA); Louise-Guy DICAIRE, Curran (CA)

(21) Appl. No.: 16/975,626

(22) PCT Filed: Feb. 26, 2018
(86) PCT No.: PCT/IB2018/051197

§ 371 Date: Aug. 25, 2020

(51) Int. Cl. G01B 11/24; G01B 11/22; G01B 11/00

(52) U.S. Cl. CPC G01B 11/24; G01S 17/894; G01B 11/002; G01B 11/22

(57) ABSTRACT

A technique for calibrating a 3D imaging system (3D-IS) that has a large field of view (FoV≥1 m³) involves: a metrological target mounted for fixed positioning with respect to an origin of the 3D-IS; a movable target plate (MTP) with at least one fiducial mark provided on a marked surface thereof; and a range and orientation measurement system (ROMS) on the MTP for measuring a distance and orientation of the MTP relative to the metrological target. The MTP is designed so that when the MTP is manipulated within the 3D-IS's FoV at an angle at which the ROMS can determine its position and orientation relative to the metrological target, at least a majority of the at least one fiducial marks is presented for coordinatization by the 3D-IS. Using such equipment, calibration involves using the measured data and the simultaneous coordinatization to calibrate.

### FIELD OF THE INVENTION

The present invention relates in general, to calibration of large field-of-view (FoV) non-contact 3D imaging systems (3D-IS) for industrial dimensional metrology, and in particular, to calibration with a moving target plate (MTP) having an on-board imaging system equipped to determine a position of the 3D-IS while the 3D-IS acquires coordinates of fiducial marks of the target.

### BACKGROUND OF THE INVENTION

Measuring object positions in space is an increasingly routine activity in industry, and is generally called industrial dimensional metrology. There is always a need for higher accuracy, higher resolution, acquisition of spatial coordinates with lower cost measurement systems and equipment, in less acquisition time, with improved accuracy and precision, and with less equipment setup and calibration time, although various application spaces have different weightings for these requirements. A variety of solutions are known. Generally these solutions vary depending largely on an accuracy and precision of the coordinatizations, a size of the volume within which objects can be coordinatized, a range of types of objects that can be acquired with a given accuracy and precision, a rate at which acquisition is provided, and an operating principle behind the detection sensing. Herein a 3D Imaging System (3D-IS) denotes a system for acquiring coordinates of objects (i.e. coordinatization). Such systems include: structured light, laser scanners, time-of-flight systems, LIDAR (including short range), RGB-D cameras, photogrammetric systems, even if the acquisition times of these various techniques may vary by 1 order of magnitude.

In the field of 3D-ISs, the concept of FoV refers to the volume over which the 3D-IS is able to perform coordinatization. As will be appreciated, small FoV 3D-ISs are fairly easy to calibrate. It is cost effective and convenient to provide a single well-characterized, and dimensionally stable, portable object, and a means for localizing the single object repeatedly within the FoV of the 3D-IS at a registered position (using exact-constraints or kinematic couplings) to accurately and repeatedly allow for recalibration with that object for the life of the 3D-IS. A small portable reference object that can be stored conveniently, that has a characterization of features that are immutable, and can be remounted to the 3D-IS in a reliable manner such that the features span the 3D-IS so greatly simplifies calibration that little more knowledge or skill than how to operate the 3D-IS are all that is required for calibration in a short period of time,.

However, large FoV 3D-ISs are not amenable to such calibration schema, because 1—any object large enough to span the FoV, and dimensionally stable enough to serve as a reference would be too large, heavy, unwieldy and expensive to use to be portable; and 2—producing a calibration process around such a reference object and certifying it, would be so challenging that very few entities could invest in it. Fixed installations (e.g. see FIG. 12 of article in Sensors specified below) producing distributions of reference features over large spatial extents are known to be the only practical solution for calibrating large FOV 3D-ISs. As the reliability of these distributed reference features are very sensitive and the structures are large and heavy, the process for calibration invariably involves moving the 3D-IS to the installation instead of the reverse. Often this is performed by the OEM who derives a revenue stream from the calibration services.

Transporting a 3D-IS to a fixed installation, calibrating it, and returning it, amount to a major cost in down-time for the owner, and increase risks of the 3D-IS being affected adversely during the transport. While small reference objects are a very easy and cost-effective way to assess whether calibration is accurate in situ, an identified failure of the calibration does not provide any alternative but to move the 3D-IS to the fixed installation.

Few 3D-IS users have space in the vicinity of the 3D-IS for such a calibrated installation. Generally 3D-ISs are required for metrology in work-space environments where many operations affecting air quality, temperature control, etc. cannot be controlled suitably for protecting the 3D-IS, and further where large mechanical equipment, vibrations, and risks of strike, are too likely. While a large enclosure over the installation could be conceived, the costs of nearly permanent occupation of a large part of the work-space surrounding the 3D-IS is likely higher than the costs of down-time for delivering the 3D-IS, even to a remote OEM. The precautions required for ensuring that the reference object is not subjected to thermal imbalance and stresses, mechanical deformations, damaging vibrations, or even surface scarring that would limit reflectivity of fiducial marks or features become onerous with larger scale reference objects. Sizes of reference objects are therefore limited by many practical constraints.

Finally coordinate measuring machines (CMM) can be used instead. Essentially a CMM is a mechatronic articulated probe for coordinatizing bodies either by mechanical contact, reflection, or imaging. Traditional CMMs could be used in place of the installation, but are not portable, and so cannot be brought to the 3D-IS.

Portable CMMs could be brought into position with respect to a 3D-IS, however these do not provide a moving target for imaging by the 3D-IS, especially one that covers any appreciable part of a volume of a large field of view 3D-IS. A number of portable CMMs could be used, or a single CMM could be repositioned many times, however the work in coordinating each reference position is unwieldy, and may require another system for measuring the positions of the CMM(s). Thus the only in situ method for calibrating a 3D-IS in the prior art appears to be to provide a second large FoV 3D-IS that is more reliably calibrated, and compare values. Of course higher reliability of the second large FoV 3D-IS is already challenged by the fact that the second 3D-IS had to be moved (even with great care and expense) to the work-space.

For example, U.S. Pat. No. 9,752,863 to Hinderling et al. provides a method for calibrating certain aspects of a time of flight (ToF) scanner with a very high volume. This method involves a plurality of target marks. Hinderling asserts that the calibration method can be carried out without re-stationing, in a single field setup of the device with unknown position of the target marks, if the target marks can be seen at different sight angles. The target marks are applied to 2 to 10 target plates, set up in different positions with respect to the device, the target plates being attached to a plumb for gravity-based orientation with at least two of the plates having a known separation.

Applicant considers the paucity of data offered by a few points of known separation, to establish that a calibration of a 3D-IS is not being performed. While simple reference objects can readily identify whether the calibration is, or is not within margins, computing a correction requires many points. For example, if two plates of known separation are found by 3D-IS imaging to have only 80% of the known separation, it cannot in principle be known whether the calibration at one or both of these points requires correction. Absent any more information, this would suggest moving both equally, but in truth there is a whole range of possible corrections that would equally resolve this error in separation, and each wrong one exacerbates errors in the existing calibration. This is not what Applicant considers to be a calibration, as it essentially lacks consistency, systematicity, and a scope of the whole FoV (or at least a relevant range thereof). That said, calibration of one or more parameters of a specific system may be sufficiently calibrated by a few points, for some satisfactory uses.

There are many known targets with markings for identifying features, and that encode different information to assist in calibration. The arrangement of the features, and known and reliable spacing of the features on a single target, or a predefined arrangement of a few targets are known to be of assistance in uniquely identifying the feature when imaged from an arbitrary perspective. For example U.S. Pat. No. 9,230,326 to Liu teaches encoded information within targets to act as “self-positioning fiducials”. These “self-positioning fiducials” are: 2D data codes that identify location of the code itself relative to plate calibration features, such that the cameras can automatically determine their position relative to the calibration plate based upon the data contained in the 2D data codes. This desirably allows for automatic, non-manual calibration of the cameras.

While some 3D-ISs boast a greater stability, in terms of longevity of accuracy and precision, all such systems need recalibration. Down-time is very expensive for users of industrial metrology, and the small risks of inaccurately certified measurement systems being quantifiable, recalibration may not be provided as regularly as would be ideal. Recalibration is an on-going expense. Accordingly, the common practice involves returning 3D-ISs to OEMs or other authorities, for recertification with some regularity. As the means for recertifying large FoV 3D-ISs are not portable, expensive, and delicate instruments, recertification remains a costly perennial problem associated with accurate 3D-ISs. Against this background, it would be desirable for a practical means for calibrating large FoV 3D-ISs in situ.

US2016/071272 to Gordon teaches a non-contact metrology probe with an (optional) reference member (28) and 3 cameras mounted to a common frame. This is useful as a non-contact probe over a very small volume. The 3 cameras are oriented to image the reference member 28, and a neighbourhood of the reference member. A tracker 20, not mounted to the cameras, has its own coordinate system, and tracks the reference member 28 (or secondary members) to provide position and orientation of the probe. While a method of calibrating this probe is taught, this probe is not taught for calibrating any other device such as a 3D-IS.

An article in Sensors (2009, 9, 10080-10096; doi:10.3390/s91210080 ISSN 1424-8220) entitled Sensors for 3D Imaging: Metric Evaluation and Calibration of a CCD/CMOS Time-of-Flight Camera, to Chiabrando et al. teaches a calibration method for ToF Cameras. FIG. 8 thereof shows a Leica TS with a plexiglass panel mounted thereto. The plexiglass panel is covered with white sheet. The camera was positioned to image the panel, while the TS rotates the panel. The Leica TS is being used as a rotation stage, and is incapable of measuring the position of the ToF camera in general, at least because the ToF camera is outside of the FoV of the TS for much of the process, but even where aligned the Leica TS is not used to record measurements, but merely as a translation stage. To use a Leica TS to calibrate a 3D-IS is a fairly conventional process where they both image a same scene from a similar vantage, and then compare differences in the points observed.

Accordingly there remains a need for a kit, and method for in situ calibration (or re-calibration) of large FoV 3D-ISs using reference objects with features that are relatively small, and can be positioned with accuracy within the FoV, where the reliability of the features and their distribution is facilitated by a size, weight, and maneuverability of the object, and a low cost system for coordinatizing the object is provided.

### SUMMARY OF THE INVENTION

Key realizations underpinning this invention were: that having the 3D-IS coordinatize the features of a mobile target plate (MTP), while a range and orientation measurement system (ROMS) onboard the MTP measures a position and orientation of the 3D-IS, gives all information required for calibration at that one point; that a collection of measurement points spanning a FoV of the 3D-IS together can provide in situ calibration over the whole volume of the 3D-IS; that the MTP can be of a size, weight and shape to facilitate movement across the volume and retain accurate positioning of the features of the MTP with respect to the ROMS; and that while the 3D-IS has a large FoV, a low cost ROMS with a far smaller FoV can be used to accurately determine the position of the 3D-IS in a cost effective, and accurate manner. The result is a cost-effective, and low total cost of ownership calibration system, that can be adapted to a wide range of 3D-ISs, having a FoV of 0.8 to 10,000 m³, or 1 to 5,000 m³, more preferably from 1.5 to 2,500 m³, from 2 to 2,000 m³, or from 4 to 1,000 m³.

Accordingly, a kit for calibrating a 3D imaging system (3D-IS) that has a field of view (FoV) of between 1 m³ and 5,000 m³ is provided. The kit comprises: a metrological target for mounting to the 3D-IS, its support, or a surface rigidly connected thereto, for fixed positioning with respect to an origin of the 3D-IS; a movable target plate (MTP) with at least two opposing broad surfaces including a marked surface, and a back surface, where: at least one fiducial mark is provided on the marked surface; the marked surface has an area of 0.01-1 m2; and a mean thickness between the marked and back surfaces less than 0.1 m; a coupling or handle integral with, mounted to, or mountable to, the MTP, the coupling or handle adapted to permit manipulation the MTP; and a range and orientation measurement system (ROMS) integral with, mounted to, or mountable to, the MTP for measuring a distance and orientation of the ROMS relative to the metrological target. The coupling or handle, ROMS and fiducial marks are configured for assembly, or assembled, on the MTP in an operable configuration in which: when the MTP is located within the 3D-IS's FoV at an orientation suitable for the ROMS to determine its position and orientation relative to the metrological targets, at least a majority of the at least one fiducial marks is presented for coordinatization by the 3D-IS. The assembled MTP is an independently movable object weighing less than 50 kg. The kit may further comprise the 3D-IS. The kit may further comprise a processor in communication with the ICs for analysis of the at least two simultaneous images for computing an instant position and orientation of the MTP relative to the metrological target.

An aspect ratio of the marked surface may be from 4:3 to 3:4, or a solid angle of the 3D-IS may be 4 times that of the ROMS.

The ROMS may comprise at least 3 imaging components, including at least one camera of fixed focal length. The imaging components are mutually spatially separated by a minimum distance of 15-150 cm, or more preferably 20-90 cm. The imaging components may be mutually spatially separated by a minimum distance that is at least 7.5% of a depth of the FoV. The imaging components and MTP may be supported by a hard frame, with the imaging components surrounding the marked surface.

The ROMS may further comprise a user interface adapted to present: an indicator of acquisition of the position and orientation; a measure of stability of the MTP throughout a 3D image acquisition; and a display of the at least one camera. The user interface may be in communication with the processor to direct the user to move the MTP within the FoV according to a plan for recalibration. The user interface may be adapted to signal a recommended pitch or yaw motion of the MTP to the user.

At least one of the ROMS, and the processor may be adapted to communicate with the 3D-IS to associate the position and orientation data of the MTP with a 3D image simultaneously acquired by the 3D-IS.

The marked surface may have an area of 0.04 to 0.7 m²; and a mean thickness of the MTP is less than 0.05 m, or an area of 0.06 to 0.5 m²; and a mean thickness of the MTP is less than 0.03 m. A square root of the marked surface's area may be 60-140% of a mean mutual separation of 3 imaging components of the ROMS.

One of the metrological target and the fiducial marks may be defined by an edge that is either linear, or an arc of a circle. The edge may be a 2D absorption coefficient contrast target, a 2D illuminated contrast target, or a 3D edge feature defined as a step between proximal and distal surfaces of the metrological target or the fiducial mark, the step being at least 0.1 mm deep. One of the metrological target and the fiducial marks may be provided by a nest for replaceably supporting a retroreflector, or by application of a sticker to a smooth, resilient and durable surface.

The coupling or handle may comprise a feature for mounting the MTP to one of: a joint, link, or end of a robotic arm, a robot end effector, a vehicle, and an articulated device operating within a FoV of the 3D-IS.

Also accordingly, a method for using the kit once assembled to calibrate the 3D imaging system (3D-IS), is provided. The method involves: moving the MTP to a first position within the 3D-IS's FoV; orienting the MTP so that its ROMS can determine its position and orientation relative to the metrological target; acquiring at each oriented position both: the position and orientation of the ROMS with respect to the metrological target, and coordinatization of the fiducial mark by the 3D-IS; and using the position and orientation and coordinatizations to calibrate the 3D-IS. The calibration may comprise locally recalibrating the 3D-IS over a volume spanned by the fiducial marks.

Also accordingly, a method for calibrating a 3D-IS is provided. The method comprises: providing a metrological target at a fixed position with respect to an origin of the 3D-IS, its support, or a surface rigidly connected thereto; providing a movable target plate (MTP) as an independently movable object weighing less than 50 kg, the MTP comprising: a range and orientation measurement system (ROMS) for measuring a distance and orientation of the MTP relative to the metrological target to a first position within a FoV of the 3D-IS; and a marked surface with at least one fiducial mark provided on the marked surface, the marked surface having an area of 0.01-1 m2, and a mean thickness less than 0.1 m; moving the MTP within the 3D-IS's FoV to an orientation suitable for the ROMS to determine its position and orientation relative to the metrological targets; coordinating the ROMS determination of position and orientation with acquisition of a 3D image of the marked surface by the 3D-IS to coordinatize the fiducial mark; and using the position and orientation and coordinatization to determine a calibration of the 3D-IS.

Providing the MTP may involve mounting the MTP on a surface that is expected to adopt a range of positions and orientations within the FoV during production work within a workspace that overlaps with the FoV; moving the MTP may involve operating a machine, vehicle, or robotic device during the production work within the workspace; and coordinating the ROMS may involve providing communications between a processor for calibration, the ROMS and the 3D-IS to signal a possibility of obtaining a calibration point, and associating 3D images with the position and orientation determinations when accurately acquired.

A complete copy of the claims is incorporated herein by reference.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which: FIGS. 1a,b are schematic illustrations of two 2D metrological targets for use in the present invention to be mounted at a fixed position with respect to an origin of a 3D-IS;

FIGS. 2a,b respectively front and side views of a schematic illustration of a movable target plate (MTP) for use in an embodiment of the present invention;

FIGS. 3a,b are respectively front and side views of a first variant of the MTP of FIGS. 2 having a round marked face and protruding fiducial marks;

FIGS. 4a,b are respectively front and side views of a second variant of the MTP of FIGS. 2 in which the fiducial marks are straight edges, and a user interface is provided;

FIG. 5 is a front view of a of a third variant of the MTP of FIGS. 2 with a mechanical Y frame structure for stabilizing imaging devices;

FIG. 6 is a flow chart showing principal steps in a method of calibration;

FIG. 7 is a schematic illustration in plan view of an assembled system for calibration with an array of calibration points provided by moving the MTP within the FoV of the 3D-IS;

FIG. 8 is a schematic illustration of a robot mounted tool with a MTP mounted thereon;

FIG. 9A is a photograph of a structured light 3D-IS with 2D metrological targets;

FIG. 9B is a photograph of a MTP constructed for demonstrating utility;

FIG. 9C is a photograph of the MTP disassembled as per a step in calibration; and

FIG. 10 is a photograph of an alternative 3D metrological target evaluated for calibration.

### DESCRIPTION OF PREFERRED EMBODIMENTS

Herein a technique for calibrating a large field of view (of 0.8 to 10,000 m³, 1 to 5,000 m³, or more preferably from 1.5 to 2500 m³, or 2 to 1,000 m³) 3D Imaging System (3D-IS) is described, especially where the FoV is contained within a sphere of 2 to 17 m radius. The radius is more preferably 3-15 m, 3.5-12 m or 4-10 m. Preferably the centre of the sphere is the 3D-IS. The choice of an efficient-sized marked surface for the moving target plate (MTP), which is at least one order of magnitude too small to span the FoV, is key to: reducing costs of making the object; improved reliability of object fidelity during use and storage; and manipulability of the reference object by humans or machines, while still providing reference feature sizes suitable for accurate coordinatization by the 3D-IS. Equipping the MTP with a low FoV, high accuracy on-board range and orientation measurement system (ROMS) makes the system functional and portable.

Moving the MTP around within the FoV adds time to the calibration process, but given the very low setup time for a single image set, which allows for the (re)calibration of the 3D-IS across the space spanned by fiducial marks of the MTP, a large number of image sets can be produced relatively quickly, allowing operators to calibrate their large FoV 3D-IS in situ, at their own schedule. Furthermore, as the weight, size and form factor of the MTP make it innocuously added to a variety of moving bodies typically (permanently, frequently, or sporadically) operating within the FoV of the (one or more) 3D-IS, such as robotic arms, moved machines, workers and vehicles, or the ground itself if the 3D-IS is mounted for motion, recalibration may be performed with opportunistic regularly, without interrupting operations, once the 3D-IS and MTP are calibrated. Calibration will be required off-line for the one or more MTPs used by the operator, but off-line 3D-IS calibration may be performed less frequently, or only with respect to regions of the FoV that are used and haven't been recalibrated recently. It will be appreciated that the regions of the FoV that are most used, are also likely the most frequently imaged with opportunistic recalibration.

Herein opportunistic calibration refers to calibration of only a region of the FoV corresponding to a region where the MTP is positioned in the course of meeting working requirements within the FoV, as opposed to positioned so for the purposes of calibration. The MTP is posed, and communications between the ROMS and 3D-IS exchange messaging to the effect that each “sees” the other (it will typically be initiated by the ROMS because it has the far narrower FoV), and if satisfactory stability of the images of both the 3D-IS and ROMS are accepted for a sufficiently overlapping temporal window, and if both images are of acceptable quality, a recalibration set is provided. The recalibration set may effectively represent a spatial trace of the MTP across the FoV. A calibration processor may choose to select from a plurality of recalibration sets that are substantially overlapping, a best set of recalibration sets, and may only apply recalibrations on request, at the interruption of a 3D-IS process, or once a batch of recalibration sets of sufficient difference (from the current calibration), or sufficient span, are collected, or the recalibration sets may be applied substantially instantaneously, depending on the processing and control architecture chosen.

The MTP defines an array of at least 4 of the fiducial marks, mounted with the ROMS that is adapted to measure, with desired accuracy, a position relative to a metrological target that is fixed with respect to the 3D-IS. While the MTP may include as few as one fiducial mark, it is substantially easier to produce a coordinatization of the marked surface with minimally 3, but preferably at least 4 fiducial marks. Moreover, subject to surface area availability, the higher the number of fiducial marks, the higher the density of points that can be accurately coordinatized by the 3D-IS, and the finer granularity the calibration achieves. The wider the spatial distribution of the marks the greater the area spanned within the FoV for a single position of the MTP, and the fewer the required number of MTP positions to span the FoV.

The ROMS may effectively be a 3D-IS, but advantageously has a FoV far smaller than that of the 3D-IS, and can therefore be less costly, more compact, and lighter than the 3D-IS. Generally the ROMS includes 3-5 spatially extended imaging components (ICs) such as charge coupled devices (CCDs) or like arrays for light detection, or laser scanners or like spatial arrays for light projection, where these 3-5, preferably 3-4, most preferably 3 ICs. At least one of the ICs is a light detection array (herein a camera). Pair-wise, each of the ICs are mutually spatially separated by a minimum distance of 15-150 cm, more preferably 20-90 cm. This separation is preferably at least 7.5% of a depth of the FoV (more preferably at least 10%).

A calibration processor, which may be a control processor of the 3D-IS, may be resident on the MTP, may be mounted temporarily or permanently with or adjacent to a target of the 3D-IS, or may be a stand-alone computer, is preferably adapted to receive coordinatization data (or output images) from the 3D-IS, and position and orientation data from the ROMS, and use calculated synchrony and/or stable observation windows to coordinate these two data streams, to produce calibration data for the 3D-IS, or to establish systematic errors on the 3D-IS images. It should be noted that with reliable, coordinated image data (or their data derivatives) from both the ROMS and 3D-IS, each fiducial mark of the MTP is of a known position and orientation (to within uncertainty), and thus can be directly compared with the 3D-IS output without requirement for any other systematization of the information, to effect (re)calibration. This is unlike the prior art to Hinderling which provides only difference information as reliably positioned and would require a complete matrix of points for calibration.

FIGS. 1a,b are schematic illustrations of targets 10A,B commonly used in industrial metrology. The targets 10A,B each define 4 fiducial edges 12 (conventionally outer edges are not used) between contrasting surfaces 14A,B. The targets 10 are primarily used for defining a position of a MTP, and so the targets 10 must be fixed with respect to the 3D-IS. Each of the targets' 10 edges 12 are arranged for convenient and accurate identification of a target centre, which may or may not be specially indicated on the target itself. The present invention will typically require at least 3 points to be uniquely identified, and preferably at least a 4^{th} for verification of the correct measurements, using targets such as those shown in FIGS. 1a,b, however in some embodiments, one dimension may be reduced by constraints and thus simplified. A single target that specifies a few or many points can be produced by trivial arrangements of targets 10, either on a single reference surface, such as a plane, or on separate reference surfaces in fixed arrangement. Preferably the at least 4 target centres of the targets 10 are separated substantially, as explained hereinbelow.

The arrangement of targets is naturally chosen to avoid occlusion of the 3D-IS, and to avoid occlusion of the targets 10 by other parts of the 3D-IS, when viewed from any viewing angle within the FoV of the 3D-IS. That way, for every position of the MTP within the 3D-IS's FoV, the ROMS can image and measure at least 3 target centres of the targets 10, and a processor can algorithmically determine a position and orientation of the MTP. Note that it is considered equivalent to measure a distance from the MTP to the targets 10 or to measure the distance from the targets 10 to the MTP, with the ego-motion assumed.

While the targets 10A,B may be individually placed on the 3D-IS, or a rigid mounting frame therefor, the targets 10 may also be placed on plates or larger structures in a more distributed manner. The greater the number and wider the spatial distribution of the target centres, as long as these are rigid and invariant positions, or can be recalibrated easily, the more accurately and reliably can the ROMS determine its position with respect to the 3D-IS. 3D-ISs that already incorporate baseline separations between elements for triangulation, such as structured light, laser scanners, and photogrammetric systems, naturally require very stiff frames for coupling the components. It is logical and reasonable to provide an arrangement of target centres on these frames for optimal distribution and utilization of the rigid structure. While rigid structures tend to be enclosed by protective structures, a number of means for providing access to the rigid structures without exposing them unduly are known. Alternatively targets 10 may be mounted to a single rigid structure for exact mounting or kinematic mounting to the hard frame of the 3D-IS, avoiding any need for recalibration. This technique may be particularly favoured when the 3D-IS has very little natural sprawl, such as RGB-D cameras or Lidar-based 3D-ISs. Finally recalibration of a metrological target that may have changed relative positions of the target centres since a last use may be performed prior to calibration.

Targets 10A,B may be 2-D contrast targets, in which case the surfaces 14A,B are differentiated by their light absorption coefficients (usually throughout at least a used portion of the NIR—visible—UV range of the electromagnetic spectrum, depending on the illumination used for measuring the target). If the target is 2-D, the bright surfaces 14B are typically chosen to provide high diffuse reflections, and low absorption and specular reflection. It is the contrast between the dark 14A and bright 14B surfaces with an ambient or directed illumination that permits the definition of the edges 12. An extreme variation in light and darkness can be provided by mirrored surfaces, with suitable illumination, or with a light source against a dark background. If a mirror is used, specular reflection would typically require light to be reflected at an exact angle from an illumination source to the target surfaces 14, onto an imaging device to produce very high contrast, retroreflectors can be used instead as high reflection surfaces. While these may not provide equally satisfactory edge definitions, which affects reliability of centre of target measurements, retroreflectors are known to provide at least 2 orders of magnitude improvement on reflected light amplitudes over white matte surfaces. Super bright LED and eye-safe laser illumination can produce even higher magnitude contrast against a black surface across a great distance, and can provide excellent edge definition. Accordingly a tradeoff is made between lighting requirements and quality of defined edges 12. Finally, if it is required to perform calibration in darker rooms, bright surfaces 14A may be provided by mirrors, and dark surfaces 14B by absorbers, and each target 14 may be independently coordinated for motion in pitch and yaw based on tracked and/or planned movement of the MTP.

Targets 10A,B may be 3-D, in which case depths (principally) differentiate the surfaces 14A,B to define the edges 12, in that each surface 14A has a different elevation than surface 14B. The edges 12 are thus defined by a vertical wall (not in view). While in practice, the elevations of each separate surface can have a different elevation, and only one of the surfaces 14A,B is used for defining a plane of the target 10A,B, it is conventional for all surfaces 14A to be coplanar, for all surfaces 14B to be coplanar, and for these two planes to be parallel. The surfaces 14A,B may be chosen to be mat and to provide for high diffuse reflections, and low absorption and specular reflection, or a hybrid 2-D, 3-D target can be provided if all surfaces 14A (or 14B) have a high enough absorbance coefficient to serve as an absorbance contrast, while providing enough diffuse reflection for reliable measurement by system. Even if absorbance of the vertical wall is minimized, any appearance of this vertical wall in images tends to distort the edge 12 locally. As the vertical wall defines the contrast of the fiducial edge, it is generally necessary for a vertical extent of the surface (i.e. the recess depth of the distal surfaces relative to proximal surfaces) to be substantially greater than a depth resolution of the imaging system used for measuring it. Typically the depth need not be greater than about 10 times the depth resolution of the ROMS (2-5 times is usually sufficient, to avoid greater costs and complexity of the target, and to minimize the edge distortion). It is desirable that 3-D targets be amenable to accurate reading over a range of view angles. Given the edge arrangements shown in FIGS. 1a,b, any edge or edge section with such a distortion has a complementary edge or edge section with no vertical wall in view. Thus these undistorted edges or edge sections can be used exclusively to define the fiducial mark in use. Preferably, however, an undercut bevel along the edge is provided to avoid the edge distortion altogether over a set of viewing angles.

While a 2-D target may be used for imaging even if the ROMS includes a laser scanning projector, substantial improvements are generally obtained with smaller edge features if a 3-D target is used. Likewise, a 3-D target might be successfully used for imaging with a purely photogrammetry-based ROMS, but a 2-D target will generally be more efficient, and allow smaller edge features to achieve comparable or better accuracy.

Target 10A shown in FIG. 1a is of a bullseye form, with the edges 12 defining concentric circles. The circles may be used to uniquely compute centres that are used as the reference point that is independent of the measurement process used to obtain them. While surfaces 14A are shown as 2 concentric bands, any other number could equally be used, and while each concentric band is shown as continuous, some conventional targets have incomplete bands that are interrupted at one or more corners, especially outside bands which have higher surface area.

Target 10B shown in FIG. 1b is of a checkerboard pattern, with edges 12 defining lines. An arbitrary selection of points on the reference edges 12 may be used to define lines, which intersect to define the centre of target. Note the centre of target itself may not be part of the edges 12. Further note that combinations of non-parallel, co-planar targets that are in view of a single image may be combined to produce a plurality of centres by pairing edges of respective targets.

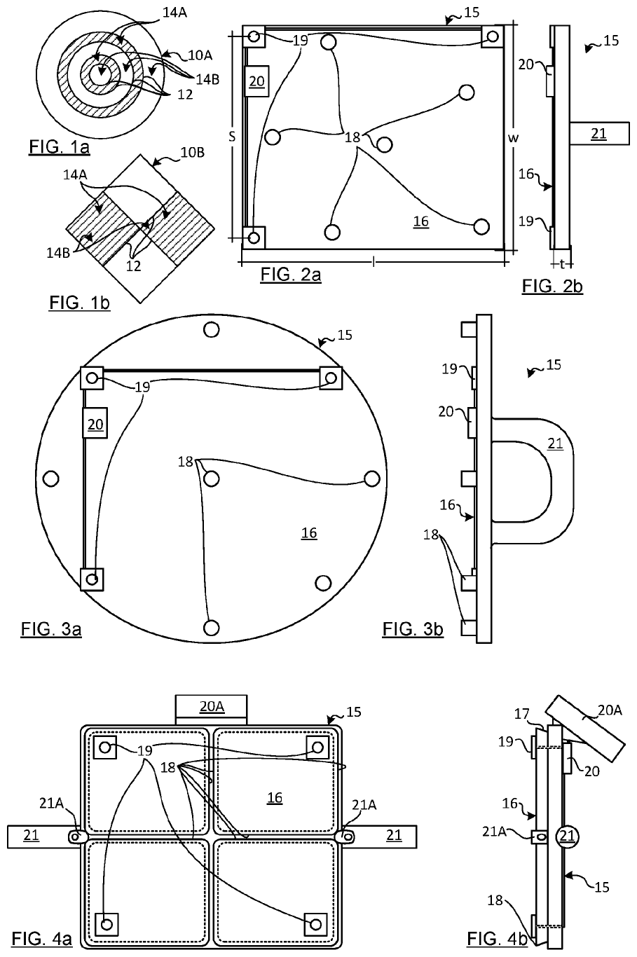

FIGS. 2a,b are schematic illustrations of a moving target plate (MTP) 15 in accordance with an embodiment of the present invention. FIG. 2a is a front view, and FIG. 2b is a side view. The MTP 15 includes a marked surface 16 with a plurality of (6) fiducial marks 18, each identical in form, providing a circular reference mark. MTP 15 is shown as a rectangular prism with the largest faces thereof being the marked surface 16 and its matching back surface. The general objective is to provide a high surface area for the marked surface 16, to permit a largest span of the fiducial marks 18 as the separation of the marks 18 corresponds with a span of the FoV of the 3D-IS covered by a single set of images. The fiducial marks are of a size, type and configuration well suited to coordinatization by the 3D-IS. At the same time, a compact and sturdy design, with low weight (under 80 kg, preferably under 50 kg, for most machine preferably under 40 kg, and ideally under 10 kg) for convenient use and storage is desired. As such the thickness (t) of the MTP (seen in FIG. 2b) would be limited to a minimum thickness of the material that is resistant to deformation and damage, and unlikely damaged in (at least) a drop test.

While a surface area of the marked surface 16 (as rectangular=I×w) may be 0.01 to 1 m², or more preferably 0.04 to 0.75 m², 0.04 to 0.6 m², or 0.06 to 0.5 m². The thickness (t) would be expected to be less than 0.1 m, such as 5 to 50 mm, or more preferably ¾ to 3 cm. While the MTP is shown as a uniform thickness plate, it will be appreciated that any slope, pattern or shape of the plate can be provided in principle, as long as a sufficient number of the fiduciary marks (or a sufficient portion of a single mark) are visible for registration and not liable to occlusion in use. For example, in order to improve strength and decrease weight, the MTP may have a structured body with the flat marked surface 16 supported by a lattice of backing ribs that together has an average thickness t.

The marked surface 16 need not be continuous. Through-holes may be arranged in the plate are as long as they don't impair image formation and analysis or identification of the fiducial features by the 3D-IS. That said, for efficient image processing techniques to apply, it is convenient for the marked surface 16 to be primarily flat and continuous. The marks are best arranged substantially uniformly around the marked surface 16 to increase a size of the 3D-IS FoV covered in an instant by the MTP 15. The marked surface 16 may preferably be rigidly coupled to a frame from a single connected region to reduce warping or thermal stresses.

The MTP 15 may also have a sacrificial border of a resilient material that will protect the fiduciary marks 18 and imaging system, and the dimensions of the marked surface 16 in the event of a drop or strike, and preferably the sacrificial border readily forms indelible marks that serve to report the accident.

The fiducial marks 18 are distributed across the marked surface 16 haphazardly in the illustrated example, but with a substantial uniformity in that the distance separating the nearest marks 18 is relatively high (more than 40% of the mean separation) and the periphery of the marked surface 16 is well represented. The fiducial marks 18 may be 2-D or 3-D, such as adhesive thin layers or, recessed bores, depending on the nature of the 3D-IS. For example, the 3D-IS may be a laser scanner, a laser tracker, or a LiDAR, and may be based on triangulation or a time-of-flight, in which case the fiducial marks may best be 3-D. The 3D-IS may be based on photogrammetry or structured light, in which case the fiducial marks may preferably be 3-D.

Rigidly attached to the MTP 15, at 3 of 4 corners, are imaging components (ICs) 19 of a ROMS 20. The ROMS 20 includes a communications-enabled processor connected to the ICs 19. A principle constraint of the size of the MTP 15 is the need for separation (S) of ICs 19 of the ROMS 20 to above a threshold for accurate imaging. While the schematic illustration is made conveniently to show the shortest separation between any two ICs 19, it will be appreciated that this arrangement is itself suboptimal: given this general shape of MTP 15, the bottom most IC 19 would be better positioned near a centre of the length I along the bottom edge to maximize separation of the ICs 19. Separation S offers a triangulation baseline for diversifying viewing/projecting angles of the ROMS 20 of/on a metrological target fixed with respect to the FoV of the 3D-IS. While, in principle, the metrological targets can be made larger and distributed spatially more widely, doing so requires higher FoV ROMS for imaging the targets, and a sprawl of the 3D-IS, even if only in calibration setup. Adding to the sprawl of the 3D-IS may only be acceptable to within certain limits, but it is an efficient way to increase an angle tolerance of the MTP for larger FoV 3D-ISs. The metrological target centre spacing, ROMS FoV, ROMS focus range, and imaging component 20 spacing are chosen to cooperate, preferably for a range of spatial setups. Typically the spacing of the metrological target centres will be at least 100 pixels when viewed by the ROMS cameras and more preferably they substantially span at least 80% of the image plane of the ROMS cameras, averaged across the 3D-IS's FoV.

At least one of the imaging components 19 is an array of light detectors, however one or more of the imaging components may be laser scanners, or structured light emitters. As a distance between the MTP 15 and metrological target 10 may be required to vary substantially, and the lighting may not be controlled in the workspace, a light source offering high power density, such as a laser, would be strongly preferred.

The MTP 15 also has a coupling or handle 21 for convenient manipulation, either by a person, or by any low vibration robotic manipulator. The coupling or handle 21 preferably allows for control over tilt and pan of the marked surface 16. The coupling may be a standard robotic tool-changer type quick connect mounting, or other standard end for coupling to a tool or robot. Furthermore the coupling can be a mounting to a variety of positions on robots other than an end effector or end of arm of the robot, or to any other moving body such as a dolly, lift truck, or vehicle regularly in use within the workspace. Depending on a weight of the MTP 15, a suitably ergonomic handle structure can be chosen including straps and harnesses for larger and heavier MTPs.

FIGS. 3, 4, and 5 illustrate three variants of the embodiment of FIG. 2. Herein like references are identified by the same numeral, and descriptions thereof are not repeated, except to note any differences. Specific combinations of variations in one or more variants can be combined to produce other embodiments of the present invention.

A first variant, shown in FIGS. 3a,b, has two parallel handles 21, and has a disk-shaped MTP 15. Only 5 fiducial marks 18 are shown. The handles 21 are located on the back side of the MTP 15, (opposite marked surface 16), spaced apart for 2 handed holding of the MTP 16. This arrangement would be best for use by a person with a MTP 15 weighing about 10 kg.

FIGS. 4a,b show front and side elevation views of a second variant of the MTP 15. The second variant has fiducial marks 18 consisting of four planar edges 18 raised against a background, in each of four raised plates on marked surface 16. For each of the raised plates, each edge is associated with two adjacent edges to define 4 centres. As such the marked surface 16 defines 16 distinct targets. Each edge is undercut 17 to improve edge definition by the 3D-IS over a range of angles of pitch and yaw.

Handles 21 and eyes 21a are two couplings or handles integral with the MTP 15, to permit manipulation the MTP 15 by a user. The handles 21 in this variation extend from a side of the MTP 15, to provide higher finesse in controlling a yaw angle of the MTP 15; and are preferably attached at a common base near a centre of the MTP 15, so that any torques applied by the handles are not communicated through the body that has the marked surface 16, but closer to a centre of mass of the MTP 15. Eyes 21a are for mounting to a strap such that a weight of the MTP 15 can principally be borne by shoulders of a user, and the hands are used for orienting the MTP 15 in pitch and yaw.

It will be noted that four ICs 19 are shown. One or two of these may be laser line projectors, or scanning laser dot projectors instead of image detectors. A redundant IC 19 may be included to provide continuous service in the event of failure of on IC 19, and may be used intermittently, or sporadically, to verify accuracy of the other 3 ICs 19, or may all be used in competition for best image for computing the range and orientation.

The second variant provides a user interface (UI) 20A for the ROMS 20. In different embodiments, the ROMS 20 may vary from a very simple input-output machine with a wireless (or in principle wireline) interface for publishing images, or data derived from the images, to a calibration controller; to a control centre for the calibration, including the calibration processor therefor. For example the ROMS 20 may have a processor that performs some tasks, such as image normalization, image quality inspection and rejection, and tracking of the metrological target across successive images, and communication with a (possibly remote) calibration processor. Either via the wireless interface, or from the resident calibration processor, the UI 20A provides preferably visual signals (though audible, thermal and even haptic signaling may be possible in some implementations) to assist in directing a calibration process. For example the UI may: inform a user when the ROMS FoV registers a required image quality of the metrological target; inform a user when the ROMS sequential images meet criteria for stability; permit a user to trigger measurement at the ROMS and 3D-IS; and/or direct the user for imaging in a trajectory that minimizes time for complete acquisition of the (re)calibration.

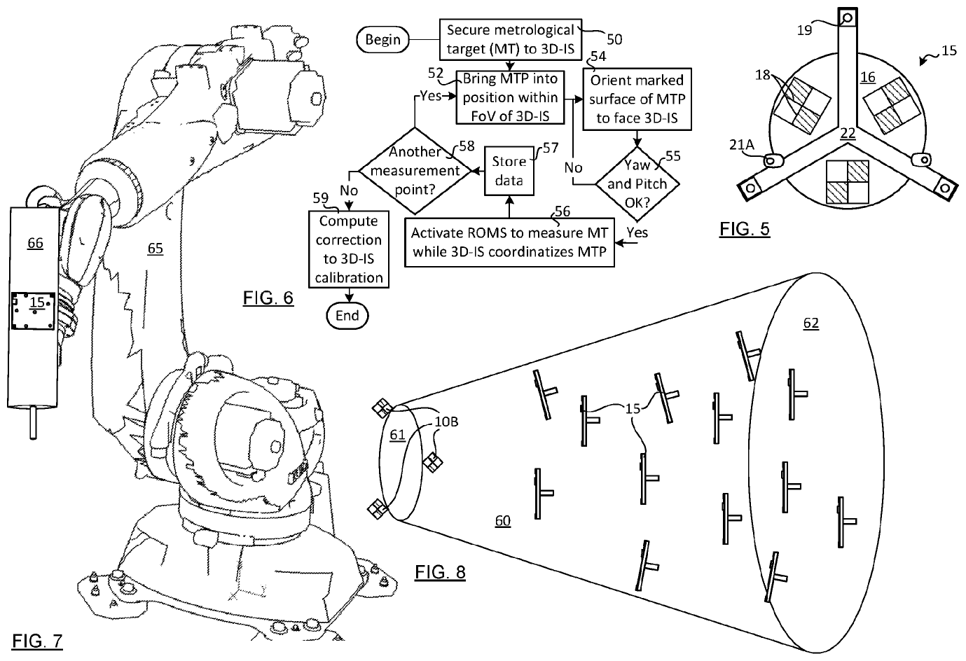

FIG. 5 is a schematic illustration of a third variant of the MTP 15. The MTP 15 is composed of a wye frame 22 that is stiff, and supports and partially encloses a disc-shaped plate featuring the marked surface 16. The wye frame 22 is preferably a symmetric structure having front and back pieces, and a slit therebetween for the disc-shaped plate. The front and back pieces are mechanically secured in the centre of the wye, where the disc-shaped plate is also affixed. By only joining the disc-shaped plate to the centre of the wye, there is little risk of thermal distortion of the disc-shaped plate. Each of 3 spokes of the wye pieces are secured at the radial ends as well, where they support the ICs 19. By defining the wye frame 22 this way, thermal modeling of the MTP 15 can be made substantially simpler. The addition of a few thermocouples or like temperature sensors facilitate thermal compensation of the MTP 15.

The marked surface 16 comprises 3 checkerboard areas each defining pairs of linear edges: one radial and one tangential. Each line of each fiducial mark is defined with precision individually and collectively such that the radial lines define a centre of the marked surface 16, and any two of the tangential lines meet at the third fiducial mark's radial line to define 3 more points, each associated with a neighbouring IC 19. As such the arrangement defines 7 reliably measured fiducial marks. Eyelets 21A are provided for clasps of a shoulder strap. Protective, and/or sacrificial materials may surround the disc-shaped plate or parts thereof, to prevent, or create a visible artifact for accidental strike. This design may be worn on a back of a person working within the workspace for opportunistic recalibration as described hereinabove.

FIG. 6 is a schematic illustration of a calibration method in accordance with an embodiment of the present invention. The process involves an equipment setup phase, which includes step 50: securing a metrological target (MT) to a 3D-IS in situ, in a workspace; and step 52 bringing a MTP into a FoV of the 3D-IS. The equipment setup phase may further involve: calibration of the MTP; testing of a calibration of the ROMS of the MTP (for example with a reference object); installing or testing lighting for the calibration; creating a temporary, coarse calibration of the 3D-IS; mounting the MTP to a movable part of a machine, vehicle, or person; and/or system warm-up processes for the ROMS cameras and 3D-IS, as conventional.

Calibration of the MTP is preferably performed by a supplier prior to delivery of the MTP. This calibration involves the ROMS calibration, and a high accuracy map of the marked surface indicating the arrangement of the fiducial marks' edges and centres. If the MTP is designed to be disassembled and reassembled for storage or delivery, preferably at least the marked surface is unaffected and the high accuracy map can be relied upon. Preferably also the spatial arrangement of the ROMS, including the relative positions of the ICs, is preserved with fidelity, in which case the only calibration needed is to reposition the marked surface relative to the ICs. This can be performed, for example, by the ROMS imaging itself in a mirror (a low quality mirror can be used if images of the edges are obtained over many positions and angles of the mirror at a constant position with respect to the MTP).

If the ROMS was disassembled or otherwise requires calibration, it is preferable that fiducial marks are provided on the ROMS, or every part thereof that is disassembled and holds one or more IC. If the mirror method is not used, a second, already calibrated MTP may be used, particularly to associate the ROMS fiducial marks with those of the marked surface to update a table defining an origin of the ROMS with respect to the marked surface, to complete the calibration of the MTP.

Calibration of the MT arrangement is unnecessary if the MT is a single reliably secured metrological target. However, if a plurality of spatially arranged MTs are used, and their spatial arrangement is either uncalibrated or unknown, this arrangement may need be calibrated for certain processes for establishing the range and orientation. This can be accomplished by computing the MT centres from a plurality of points of view by the MTP, and extracting the relative positions from the images. As this is a relatively fast and efficient process, it may be performed even on reliable single rigid object MTs during the equipment setup phase.

At step 54 the marked surface of the MTP is oriented towards the 3D-IS. This may be accidentally, as in the case of opportunistic recalibration, or may be guided by a calibration program. If opportunistic recalibration is chosen, the MTP will continuously run a program for detecting the target associated with the 3D-IS. Whenever the MT is in view, the yaw and pitch will be considered correct.

If the (re)calibration is not opportunistic, the calibration process may use orientation (relative or position and orientation) tracking software (for example using either output of the 3D-IS and/or ROMS or even a compass, workspace model/map, GPS, accelerometer), with feedback supplied to the user via a UI to guide the user to adjust the pitch and yaw until it is correct as determined at step 55. Alternatively ROMS information alone can give operator feedback indicating some cameras or all cameras (any other ICs) are viewing (some number of) the MT(s), without any information exchanged with the calibration processor. Furthermore an image of one of the cameras (or a derivative data product from the three or more ICs) may be displayed to the user for the user to determine whether the MT is in view for the user to determine whether pitch and yaw are acceptable.

A variety of protocols can be used to synchronize acquisitions of the position of the MT centre by the ROMS with acquisition of the 3D-IS coordinatization of the MTP (step 56). There may be an exchange of information between the 3D-IS and MTP prior to acquisitions, or the 3D-IS may be in continuous operation with an instantaneous, or off-line marriage of two data streams. Alternatively triggers for both the MTP and 3D-IS may be sent by the calibration processor prior to an acquisition. Moreover timestamps for the ROMS data and 3D-IS data may be used without any triggers to coordinate data streams for association of the data. Thus whole batches of data may be dumped for off-line analysis and coordination of the data, for evaluating the data, stability of the images, lighting artefacts, accuracy of the range and orientation measures at each frame having regards to subsequent and preceding frames, and operating properties of the ROMS, 3D-IS, and the marked surface, if instrumented.

Data is preferably stored for traceability of the calibration, at step 57, and for further processing. While the process flow of FIG. 6 shows data points stored individually and then in bulk used to compute a correction to the 3D-IS, it will be appreciated that each individual point is a complete local correction to the calibration, and a point-wise update to a calibration table of the 3D-IS may be computed at step 57, assuming the measures are all within uncertainty. These updates may be applied immediately, or in bulk once a certain measure of remediation is observed to the calibration of the 3D-IS, or a time since calibration of the neighbourhood has been observed, in dependence upon a sensitivity of the 3D-IS process, or in any manner efficient for the operation of the 3D-IS. It will be appreciated that 3D-IS output is frequently used as inputs to other systems and the update to the calibration table may be used upstream of the 3D-IS itself.

It is determined at step 58 whether another measurement point is coming. If the process is opportunistic, this may be determined by exit of a vehicle, person, or moving body from the workspace, or by powering down the ROMS or 3D-IS. If a calibration processor is guiding the collection of points, the calibration processor will direct the user to where a next point would be preferentially taken to minimize a time and produce a desired quality of the calibration, and the process will return to step 52. Once all measurement points are taken, a correction to the 3D-IS calibration is computed (step 59). This may be used to update a table of the 3D-IS, either internally, or for use by equipment that takes the 3D-IS output and uses it for particular purposes.

FIG. 7 is a schematic illustration of a robot 65 having an end effector 66 onto which is mounted a MTP 15. It will be appreciated that placement of a MTP on a robot is a sensitive choice. To avoid adding any further constraints to mobility of the robot, the MTP is mounted to the robot within its working envelope. It is expected that locations near a wrist of the robot and along links of the robot may be ideal locations for mounting the MTP. A trade-off in separation S of the ICs may be required to avoid enlarging the robot envelope, or the robot envelope may be extended. If the separation S is made smaller, it reduces a set of positions and orientations over which the ROMS can image and determine with required accuracy a distance to, the MT(s). It will be noted that mounting the MTP to an end effector may be a good choice because a size of the end effector may be relatively large, and frequently is presented for view, compared with a wrist of the robot, although other joints may be regularly in view as well.

An advantage of placing the MTP on a robot is that the recalibration of the 3D-IS is performed in the vicinity of the locus of action, which is presumably where calibration would be most critical. The ROMS may rarely operate over certain parts of the FoV of the 3D-IS, which may be acceptable, especially if the robot is in an extreme pose at that part of the FoV and little critical activity occurs within that range of the FoV.

While the MTP is shown particularly as mounted to robot 65 for situated, opportunistic recalibration, it could equally have been mounted to a gantry-style machine, or other moving, mobile, or stationary tools or equipment within the FoV, such as vehicles, trucks, carts, etc. as well as workers.

FIG. 8 is a schematic illustration of a time overlapped image of a calibration process, showing how calibration points can be taken at a number of points within a 3D-IS's FoV 60. The FoV 60 is shown as a pyramidal frustum as is naturally defined by a solid angle of the 3D-IS (view pyramid), bounded by front (61) and rear (62) planes (or spheres centered on the origin) that define the bounds within which the 3D-IS operates. Three checker-board style MTs 10B are shown for reference, and 13 instances of the MTP 15 (of FIG. 2) are shown distributed within the FoV 60.

It will be noted that highest uncertainties of the 3D-IS may be at a greatest distance from an origin of the 3D-IS in the FoV (along the rear plane or sphere 62), or in two bands respectively along the rear plane or sphere 62 and along the front plane or sphere 61. While FIG. 7 shows a same MTP 15 used throughout, two different MTPs having ROMS with different respective separations S of ICs can be used. For example, a MTP with a smaller S can be used for a proximal range of FoV depths within which an accuracy of the position is satisfactory, and a second MTP with a larger S can be used for a distal range of depths. Preferably the two ranges of depths overlap.

### EXAMPLE

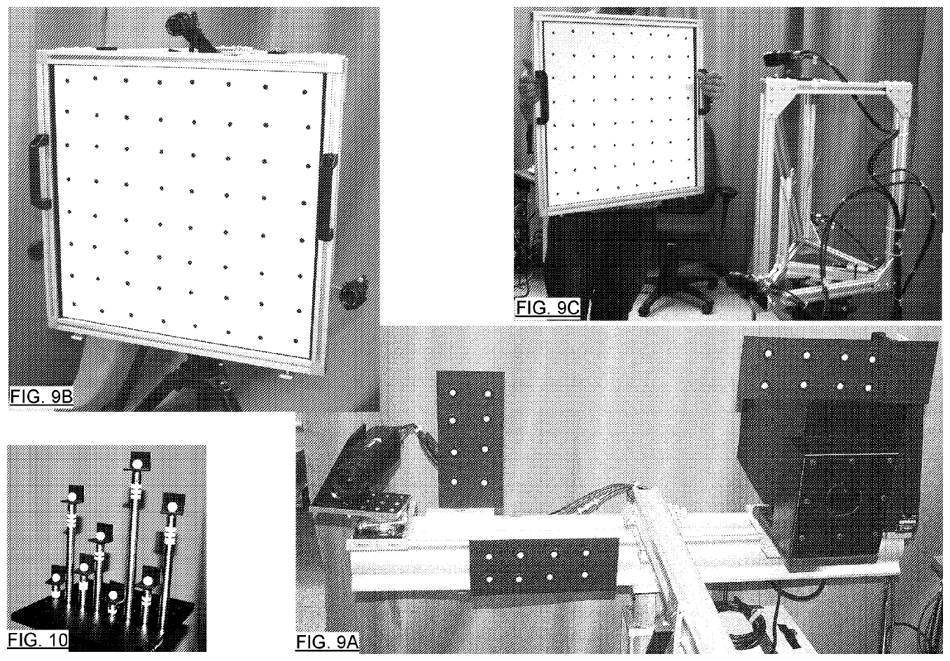

The present invention has been demonstrated using a structured light 3D-IS (SLS) (FoV of ˜8 m³=2 m×2 m×2 m) as shown in FIG. 9A. The structured light SLS includes a stand, a special purpose projector with optics as taught in Applicant's patent U.S. Pat. No. 8,754,954, a camera, and a computer for collecting data and applying a deconvolution process as explained in Applicant's patent U.S. Pat. No. 8,411,995. The MTP has also been used to calibrate.

FIG. 9A also shows a series of MTs in the form of standard photogrammetric markers. The markers were applied as photogrammetric stickers (Synthetic paper: Mactac metro label white perm; the dots are 1 cm diameter, and surrounded by black ink printed by Spicers Canada ULC on commercial printer) that were mounted to respective steel plates. The stickers are black with white circular targets having a high absorbance contrast to define the target. The minimum number of sticker is three, typically we use 24 markers. The 24 targets were provided on 3 separate plates having 8 targets each. The stickers were applied by hand and did not have a prescribed arrangement on the plate, although they were generally spaced by about 5 cm from the 2 or 3 nearest dots. Two steel plates are horizontally arranged, the right most steel plate being separated from the other horizontal steel plate by 40 cm vertically upwards and 18 cm left to right (nearest corners), and the vertically arranged steel plate is 12 cm behind the horizontally arranged steel plates.

While FIG. 9A shows a MT consisting of a matte white (high reflectance) on a black (high absorbance) background, Applicant has found that using retroreflective targets allows for a much higher (˜2 orders of magnitude) reflectance which can be helpful for reducing illumination requirements. While edges of the retroreflective targets are not defined as nicely as these sticker-applied markers, the speed of imaging of the ROMS camera can be reduced substantially and this improves stability of the images and accuracy of measurements.

FIGS. 9B,C are photographs of a prototype MTP. It is composed of a calibration plate, a frame with three cameras, and a computer. FIG. 9B shows the MTP assembled, and FIG. 9C shows the MTP with the calibration plate disassembled. The frame is mounted on a rolling tripod to ease the moving of the self-positioning target. Note that the computer could be installed on the frame.

The three cameras are mounted on the frame with a distance between the two cameras on the bottom being 30 inches, and a distance between either bottom camera and the top is 25 inches. The focal length distance of the cameras is set to 2.5 m. The technical operating specifications of the camera are: XIMEA™, model MC124MG-SY, Bus type USB 3, 1 monochrome channel, frame rate: 10 fps, dynamic interval: 10 bits, pixel pitch: 5.5 μm, resolution: 12 M pixels, and aperture: F8. A thermocouple sensor was embedded in the camera and used for image correction.

Two different types of calibration plates were tested for fitness. The selection of the type of target depends mostly on the accuracy and resolution of the SLS system to be calibrated. Table 1 provides construction details for two designs. FIGS. 9B,C show the glass-based calibration plate. It is noted that certain glass, and monocrystalline ceramics have lower thermal expansion coefficients, which can be useful, and high ceramic content metal matrix composites (such as Applicant's WO2014/121384), or even thin natural or artificial granite plates, can have good stiffness to weight ratios, excellent stability, and reasonable manufacturability.

TABLE 1

| | Lower accuracy target | Higher accuracy target |
|---|---|---|
| Material | Glass | Machined Stainless |
| | | steel or aluminium. |
| Surface processing | Painted | Vaper blasted |
| Circular Fiducial | Laser hatching or | Photogrammetric |
| marker | photogrammetric target | target mounted by |
| | printed on synthetic paper | press fit. |
| | and adhered to the surface | |
| Mounting on frame | Nuts and bolts mounting | Kinematic mounts |
| | hardware | with redundant back |
| | | up fasteners |
| Weight | 10 pounds | 40 pounds |
| Temperature probe | None | thermocouple sensor |

The size of the calibration plate was decided based on many factors. To reduce a number of images of the MTP required to span a FoV, the calibration plate should be as large as possible. However, larger plates with tight tolerances on the flatness and fiducial marker positions are far more expensive to build. Practical concerns like weight and portability favor smaller plate sizes. In general it is practical to use plate sizes that are commensurate with the separation S used (such as 60%-140% S, more preferably 75%-120% S), as the rigid structure for supporting the cameras can also serve to support and/or protect the plate. The calibration plates were 26 by 26 inches.

The frame was designed so that the calibration plate can be detached. In disassembled form the MTP is conveniently transported or stored. The re-assembly is not need to be repeatable). The frame was designed to be sufficiently rigid such that the cameras do not move with respect to the calibration plate, or each other, when the self-positioning target is moved or subjected to vibration. Stiff, lightweight, vibration absorbing, low coefficient of thermal expansion, materials are preferred. The photographed frame is made of Aluminum, which is stiff and relatively lightweight, but does not have the best CTE. Plans for a lighter and stiffer structure made out of carbon fibre reinforced polymer, and for a design resembling FIG. 5, are in the works.

The controlling hardware is not shown in the drawings, but is essential to implementation. The controlling hardware included a HP Z-400 workstation, which executes many functions. First, it is responsible for the synchronization all the cameras of the ROMS. The cameras were USB connected to the controlling hardware via a USB device NI-USB-6001 from National Instruments. The USB device generates an electronic trigger signal for ROMS camera synchronization. A second function is to send a signal to the SLS to prompt acquisition by the SLS, of a 3D image of the FoV. This is specifically performed with an Ethernet network connection that is established between the SLS and the controlling hardware. In an industrial setting, a wireless network or infrared transmission network could alternatively be used. The third function is to monitor the movement of the MTP with respect to the SLS while the SLS is acquiring the 3D image (this is performed in structured light systems, by a succession of images with different illumination patterns in successive time steps). The movement monitoring is done by measuring the variation of position of the marker in the image taken by the ROMS throughout the 3D image acquisition. As the ROMS takes many images while the 3D image is being acquired by the SLS, a stability of the MTP throughout the SLS imaging is assessed and used to ensure that any errors in the measured positions of the calibration plate features are not attributed to the motion of the MTP, as opposed to the calibration of the 3D-IS. Accelerometers on-board the MTP could be used to assist this monitoring. A fourth function of the controlling hardware is to continuously track the position of the photogrammetric markers in the images of the three cameras, and compute the position and orientation of the self-positioning target using this position. Finally, the controlling hardware reads the temperature probes, assesses the stability of the MTP throughout the SLS 3D image acquisition, and determines the position and uncertainty of the position and orientation of the calibration plate, to associate an error in the SLS calibration with each measurement position.

The frame and the calibration plate are expected to be subject to temperature variation. For this reason, temperature probes may be installed on both the calibration plate and the frame when the system is expected to work in an uncontrolled environment. For example, air temperature measurements, as well as surface temperature readings of the calibration plate and frame, may all be used with a suitable model of the system to determine displacements of the cameras, and variations of positioning of the camera centres with respect to a centre of the calibration plate. The temperature information is communicated to the controlling hardware that applies temperature correction to the position and orientation computed by the ROMS.

### Calibration Example

The procedure for calibrating the SLS required first calibration of the MTP than it would be for workspace deployment. An initial step was required because the MTP was not calibrated itself. This same step would be required any time the MTP itself may have been modified since its last calibration. If the MTP is not made for disassembly, this step will less frequently be required for deployment on a workspace.

When commissioning the MTP or recalibrating the MTP, one must measure the position of the fiducial marks on the calibration plate; and calibrate the cameras. Typically, the calibration plate measurement will be performed using a CMM with an imaging system. Typically the work would be done by a recognized laboratory of metrology, and will provide traceability of the measurements with the MTP.

This camera calibration step may be performed when the cameras or frame are changed or at some regular time interval (once a month) in order to verify that the system is stable. The objective of this step is to calibrate the intrinsic parameters of each camera and calibrate the rigid transformation between all cameras (orientation and position). This calibration was performed using the technique known as planar calibration [Z. Zhang, “A flexible new technique for camera calibration”, in IEEE Transactions on Pattern Analysis and Machine Intelligence, vol. 22, no. 11, pp. 1330-1334, November 2000, the contents of which are incorporated herein by reference]. To perform this calibration we use the plate that can be unmounted from the self-positioning target. Note that the size of the plate is such that it covers the entire volume in which the cameras can triangulate points. Thus the camera ring is designed to work on a volume for which it is practical to build an accurate and cost efficient calibration plate. Having a calibration plate that covers the entire volume allows a more accurate calibration than using a small target (without self-positioning capability) that is moved in the volume. The calibration of the camera ring requires many images of the plate at different orientations with respect to the camera ring. The temperature of the plate, cameras and frame are recorded during this calibration. Once the calibration is performed, the plate is carefully reinstalled on the frame and the MTP is ready to be used. Note that the procedure does not assume that the plate will always be positioned at the same position when it is remounted on the frame.

With the calibrated MTP, computing a 3D position of the photogrammetric markers that are fixed with respect to an origin of the SLS is performed. This step would be avoided if the photogrammetric markers (or other metrological target) were rigidly and reliably mounted to the 3D-IS (SLS) on sale of the system. As this was not the case for our test system, photogrammetric markers were installed on the SLS. While 24 targets were used, our next embodiment will use 40 markers (10 markers on each of 4 plates). The MTP was brought in front of the SLS. Each of the three cameras of the ROMS imaged the photogrammetric markers. Relying on the calibration of the ROMS, the position of the center of each fiducial marker is computed. Thus, a reconstruction of the 24 targets in 3D is achieved.

This 3D reconstruction process can be repeated each time the self-positioning target is or may have moved during the SLS calibration step. Since the marker is placed on the SLS, and the SLS is a rigid object that does not change form, it is possible to find the rigid transformation between each position of the self-positioning target. This allows for the computation of the position of the three cameras with respect to the SLS at each image acquisition. However, this does not provide us with the position of the plate since the rigid transformation between the plate and the cameras is unknown.

An initial calibration of the SLS was required, for the process to work. Again this step would not be performed in a workspace deployment, as the 3D-IS/SLS would already be bought with an initial calibration, unless the calibration file were lost or destroyed. If a SLS calibration of another SLS of the same model cannot be obtained, an initial calibration would have to be recovered. We simply used two images of the calibration plate of the MTP and performed a planar calibration with that data given the known map of the calibration plate. Note that this is a temporary calibration that does not need to be accurate.

The next step was computing the rigid transformation between the camera of the ROMS and the markers on the calibration plate. An artifact is needed for computing the rigid transformation between the cameras and the plate. In our experiment, we used the artifact shown in FIG. 10. This artifact is composed of 8 spheres. Note the presence of a black bracket at the base of each sphere. The bracket can be rotated 360 degrees around the base of the spheres so that the bracket can be placed behind the sphere for any viewing angle of the artifact in the plane, without moving the artifact itself. As such the white spheres were provided in front of a black background for imaging by the MTP or the SLS, which ever was imaging the artifact. The positions of the spheres on the artifact were measured using the ROMS cameras using the triangulation process used to measure the photogrammetric markers.

The artifact is placed between the MTP and the SLS such that the MTP and SLS can both image the artifact (with the brackets suitably positioned). The MTP is then used to triangulate the position of the photogrammetric markers and the position of the artefact in the same reference frame. Using the temporary calibration of the SLS camera, we recovered the relative pose of the SLS camera with respect to the artifact. Knowing both the pose and the measurement taken by the MTP, we computed the relative position and orientation of the SLS camera with respect to the photogrammetric markers installed on the SLS. Note that the recovered relative position and orientation of the SLS camera with respect to the photogrammetric markers is only used as an initialization during the SLS calibration.

Finally, we calibrated the SLS in two steps: the first was data acquisition and required approximately an hour of labor; the second was data processing which typically required a few minutes. The data acquisition involved placing the MTP in the FoV of the SLS, and the positioning the MTP. Using the orientation and position of the ROMS camera with respect to the calibration plate, and the temporarily SLS calibration, we predicted the position in the 3D image from the SLS, of the fiducial markers on the calibration plate. Standard image processing methods were used to refine this position. The MTP was moved while its controlling hardware continuously tracked the photogrammetric markers. Once the MTP stopped moving (stability was observed), another acquisition of the SLS camera was performed. For each position of the MTP, we extracted the position of the SLS with respect to the target and a list of correspondences between the positions of the fiducial markers and their images into the SLS camera was produced. This acquisition is repeated multiple times such that the entire reconstruction volume of the SLS is covered.

Once all the data was collected, a non-linear bundle adjustment (see [Triggs B., McLauchlan P. F., Hartley R. I., Fitzgibbon A. W. (2000) “Bundle Adjustment A Modern Synthesis.” In: Triggs B., Zisserman A., Szeliski R. (eds) Vision Algorithms: Theory and Practice. IWVA 1999. Lecture Notes in Computer Science, vol 1883. Springer, Berlin, Heidelberg], the contents of which are incorporated herein by reference) was used to improve the calibration the SLS and find the rigid transformation between the camera of the SLS and the photogrammetric markers. The exact mathematical model minimized depends on the distortions of the optical system of the SLS, specifically, in the present SLS, where a large field of view lens (fish-eye camera) substantial radial distortions are corrected, as well as some minor tangential distortions (to correct deviations from a pin-hole model).

### Comparison of Calibration with MTP

The calibrated SLS was compared with the only other technique that might be used in an industrial workspace: calibration with a laser tracker. The laser tracker costs about 25 times the cost of the MTP (not counting the time to construct) and the time it took to calibrate the SLS was 2-3 days. The laser tracker imaged the marked surface of the MTP at a few positions per minute. The frame of the shown MTP was outfitted with three nests for spherically mounted retroreflectors, one near each of the cameras. The ROMS was deactivated, and the laser tracker data was acquired during the SLS acquisition of a 3D image.

Both calibrations were tested using a flat plate and were found to have the same mean accuracy. The form errors of the data of planar surfaces scanned by the SLS calibrated using both the laser tracker and the self-positioning target, were similar (about 0.3 mm) and mostly the result of the range uncertainty of the SLS.

Applicant has demonstrated a very low cost, high accuracy calibration system for 3D-ISs.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A kit for calibrating a 3D imaging system (3D-IS) that has a field of view (FoV) of between 1 m³ and 5,000 m³, the kit comprising:
a metrological target for mounting to the 3D-IS, its support, or a surface rigidly connected thereto, for fixed positioning with respect to an origin of the 3D-IS;
a movable target plate (MTP) with at least two opposing broad surfaces including a marked surface, and a back surface, where: at least one fiducial mark is provided on the marked surface; the marked surface has an area of 0.01-1 m²; and a mean thickness between the marked and back surfaces less than 0.1 m;
a coupling or handle integral with, mounted to, or mountable to, the MTP, the coupling or handle adapted to permit manipulation the MTP; and
a range and orientation measurement system (ROMS) integral with, mounted to, or mountable to, the MTP for measuring a distance and orientation of the ROMS relative to the metrological target; wherein
the coupling or handle, ROMS and fiducial marks are configured for assembly, or assembled, on the MTP in an operable configuration in which: when the MTP is located within the 3D-IS's FoV at an orientation suitable for the ROMS to determine its position and orientation relative to the metrological targets, at least a majority of the at least one fiducial marks is presented for coordinatization by the 3D-IS; and
the assembled MTP is an independently movable object weighing less than 50 kg.

2. The kit of claim 1 further comprising the 3D-IS.

3. (canceled)

4. (canceled)

5. The kit of claim 1, wherein the ROMS comprises imaging components, including at least one camera of fixed focal length.

6. (canceled)

7. (canceled)

8. The kit of claim 4, wherein the imaging components are mutually spatially separated by a minimum distance that is at least 7.5% of a depth of the FoV.

9. The kit of claim 5, wherein the imaging components and MTP are supported by a hard frame, with the components surrounding the marked surface.

10. The kit of claim 5, further comprising a processor in communication with the [ICs] imaging components for analysis of the at least two simultaneous images for computing an instant position and orientation of the MTP relative to the metrological target.

11. The kit of claim 5, wherein the ROMS further comprises a user interface adapted to present: an indicator of acquisition of the position and orientation; a measure of stability of the MTP throughout a 3D image acquisition; and a display of the at least one camera.

12. The kit of claim 11, wherein the user interface is in communication with the processor to direct the user to move the MTP within the FoV according to a plan for recalibration.

13. The kit of claim 11, wherein the user interface signals a recommended pitch or yaw motion of the MTP to the user.

14. The kit of claim 1, wherein at least one of the ROMS, and the processor is adapted to communicate with the 3D-IS to associate the position and orientation data of the MTP with a 3D image simultaneously acquired by the 3D-IS.

15. (canceled)

16. (canceled)

17. (canceled)

18. The kit of claim 1, wherein one of the metrological target and the fiducial marks is defined by an edge that is either linear, or an arc of a circle.

19. The kit of claim 18, wherein the edge is at least one of a 2D absorption coefficient contrast target and a 2D illuminated contrast target.

20. (canceled)

21. The kit of claim 18, wherein the edge is a 3D edge feature defined as a step between proximal and distal surfaces of the metrological target or the fiducial mark, the step being at least 0.1 mm deep.

22. The kit of claim 1, wherein one of the metrological target and the fiducial marks is provided by at least one of a nest for replaceably supporting a retroreflector and a sticker to a smooth, resilient and durable surface.

23. (canceled)

24. The kit of claim 1, wherein the coupling or handle comprises a feature for mounting the MTP to one of: a joint, link, or end of a robotic arm, a robot end effector, a vehicle, and an articulated device operating within a FoV of the 3D-IS.

25. A method for using the kit according to claim 1 once assembled to calibrate the 3D imaging system (3D-IS), the method comprising:
moving the MTP to a first position within the 3D-IS's FoV;
orienting the MTP so that its ROMS can determine its position and orientation relative to the metrological target;
acquiring at each oriented position both: the position and orientation of the ROMS with respect to the metrological target, and coordinatization of the fiducial mark by the 3D-IS; and
using the position and orientation and coordinatizations to calibrate the 3D-IS.

26. The method of claim 25, wherein the calibration comprises locally recalibrating the 3D-IS over a volume spanned by the fiducial marks.

27. A method for calibrating a 3D imaging system (3D-IS), the method comprising:
providing a metrological target at a fixed position with respect to an origin of the 3D-IS, its support, or a surface rigidly connected thereto;
providing a movable target plate (MTP) as an independently movable object weighing less than 50 kg, the MTP comprising:
a range and orientation measurement system (ROMS) for measuring a distance and orientation of the MTP relative to the metrological target to a first position within a field of view (FoV) of the 3D-IS; and
a marked surface with at least one fiducial mark provided on the marked surface, the marked surface having an area of 0.01-1 m², and a mean thickness less than 0.1 m;
moving the MTP within the 3D-IS's FoV to an orientation suitable for the ROMS to determine its position and orientation relative to the metrological targets;
coordinating the ROMS determination of position and orientation with acquisition of a 3D image of the marked surface by the 3D-IS to coordinatize the fiducial mark; and
using the position and orientation and coordinatization to determine a calibration of the 3D-IS.

28. The method of claim 27 wherein:
providing the MTP comprises mounting the MTP on a surface that is expected to adopt a range of positions and orientations within the FoV during production work within a workspace that overlaps with the FoV;
moving the MTP comprises operating a machine, vehicle, or robotic device during the production work within the workspace;
coordinating the ROMS comprises providing communications between a processor for calibration, the ROMS and the 3D-IS to signal a possibility of obtaining a calibration point, and associating 3D images with the position and orientation determinations when accurately acquired.

29. A kit for calibrating a 3D imaging system (3D-IS) comprising a field of view (FoV), the kit comprising:
a metrological target for mounting to the 3D-IS, its support, or a surface rigidly connected thereto, for fixed positioning with respect to an origin of the 3D-IS;
a movable target plate (MTP) with at least two opposing broad surfaces including a marked surface, and a back surface, where: at least one fiducial mark is provided on the marked surface;
a coupling or handle integral with, mounted to, or mountable to, the MTP, the coupling or handle adapted to permit manipulation the MTP; and
a range and orientation measurement system (ROMS) integral with, mounted to, or mountable to, the MTP for measuring a distance and orientation of the ROMS relative to the metrological target; and wherein
the coupling or handle, ROMS and fiducial marks are configured for assembly, or assembled, on the MTP in an operable configuration in which: when the MTP is located within the 3D-IS's FoV at an orientation suitable for the ROMS to determine its position and orientation relative to the metrological targets, at least a majority of the at least one fiducial marks is presented for coordinatization by the 3D-IS; and
the assembled MTP is an independently movable object.
